(19) United States
(12) Patent Application Publication
(10) Pub. No.: US 2014/0282185 A1
(43) Pub. Date: Sep. 18, 2014

(54) MODIFYING COLORS IN A COLOR HARMONY

(71) Applicant: COREL CORPORATION, Ottawa (CA)

(72) Inventor: Adam John Michael Letts, Ottawa (CA)

(73) Assignee: Corel Corporation, Ottawa (CA)

(21) Appl. No.: 13/837,431

(22) Filed: Mar. 15, 2013

(51) Int. Cl. G06F 3/0484

(52) U.S. Cl. CPC G06F 3/0484
USPC 715/771

(57) ABSTRACT

A method for controlling color styles in a graphics application program includes the steps of selecting a plurality of color styles and grouping the color styles into a harmony. The method further includes the step of displaying a color model graphical user interface representative of each color style in the harmony. The method further includes the steps of creating a rule in program instructions for the graphics application program to constrain at least one color component of the color model graphical user interface, selecting a base color style within the color model graphical user interface for editing, and invoking the rule so the computer executes instructions to constrain the color component. The method further includes the steps of modifying a color component of the base color style with the graphical user interface while in the constrained state, and proportionately modifying the corresponding color component of the remaining color styles in the color model graphical user interface.

### FIELD OF THE INVENTION

This disclosure relates generally to graphic computer software systems and, more specifically, to a system and method for creating and controlling computer graphics and artwork.

### BACKGROUND OF THE INVENTION

Graphic software applications provide users with tools for creating drawings for presentation on a display such as a computer monitor or tablet. One such class of applications includes drawing software, in which computer-generated images simulate the look of handmade drawings or paintings. Graphic software applications such as drawing or painting software can provide users with a variety of color selections.

To create or modify a color in a drawing, the user may be presented with a graphical user interface to help visualize the color selection. However, as the popularity of graphic software applications flourish, and the software becomes more complex, adding new features and capabilities, traditional color user interfaces may be inadequate.

### SUMMARY OF THE INVENTION

In one aspect of the invention, a method for controlling color styles in a graphics application program executing on a computer is disclosed. The method includes the steps of selecting a plurality of color styles, and grouping the color styles into a harmony. The method further includes the step of displaying a color model graphical user interface representative of each color style in the harmony. The method further includes the steps of creating a rule in program instructions for the graphics application program to constrain at least one color component of the color model graphical user interface, selecting a base color style within the color model graphical user interface for editing, and invoking the rule so the computer executes instructions to constrain the color component. The method further includes the steps of modifying a color component of the base color style with the graphical user interface while in the constrained state, and proportionately modifying the corresponding color component of the remaining color styles in the color model graphical user interface.

In another aspect of the invention, a digital graphics computer system is disclosed. The system includes a computer comprising one or more processors, one or more computer-readable memories, one or more computer-readable tangible storage devices, and program instructions stored on at least one of the one or more storage devices for execution by at least one of the one or more processors via at least one of the one or more memories. The system further includes a display connected to the computer. The computer program instructions include program instructions for executing a graphics application program and output to the display, and program instructions for selecting a plurality of color styles and grouping the color styles into a harmony. The computer program instructions further include program instructions for displaying a color model graphical user interface representative of each color style in the harmony, creating a rule to constrain at least one of the color components of the color model graphical user interface, selecting a base color style within the color model graphical user interface for editing, invoking the rule so the computer executes instructions to constrain the color component of the color model graphical user interface, modifying a color component of the base color style with the graphical user interface while in the constrained state, and proportionately modifying the corresponding color component of the remaining color styles in the color model graphical user interface.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 depicts a functional block diagram of a graphic computer software system according to one embodiment of the present invention;

FIG. 2 depicts an application window within the graphics application program of the graphic computer software system shown in FIG. 1;

FIG. 3 depicts a graphical user interface for choosing a color style within the graphics application program;

FIG. 4 depicts a graphical user interface to modify a constrained color harmony in accordance with one embodiment of the present invention;

FIG. 5 depicts graphical user interfaces for invoking harmony rules in accordance with one embodiment of the present invention; and

FIG. 6 depicts a harmony rule graphical user interface in accordance with one embodiment of the present invention.

### DETAILED DESCRIPTION OF THE INVENTION

According to various embodiments of the present invention, a graphic computer software system provides a solution to the problems noted above. The graphic computer software system includes a new graphical user interface that permits constraining certain color components while modifying a color style.

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Program code embodied on a computer-readable medium may be transmitted using any appropriate medium, including but not limited to wireless, wireline, optical fiber cable, RF, etc., or any suitable combination of the foregoing.

Computer program code for carrying out operations of the present invention may be written in any combination of one or more programming languages, including an object oriented programming language such as PHP, Javascript, Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

With reference now to the figures, and in particular, with reference to FIG. 1, an illustrative diagram of a data processing environment is provided in which illustrative embodiments may be implemented. It should be appreciated that FIG. 1 is only provided as an illustration of one implementation and is not intended to imply any limitation with regard to the environments in which different embodiments may be implemented. Many modifications to the depicted environments may be made.

FIG. 1 depicts a block diagram of a graphic computer software system 10 according to one embodiment of the present invention. The graphic computer software system 10 includes a computer 12 having a computer readable storage medium which may be utilized by the present disclosure. The computer is suitable for storing and/or executing computer code that implements various aspects of the present invention. Note that some or all of the exemplary architecture, including both depicted hardware and software, shown for and within computer 12 may be utilized by a software deploying server and/or a central service server.

Computer 12 includes a processor (or CPU) 14 that is coupled to a system bus 15. Processor 14 may utilize one or more processors, each of which has one or more processor cores. A video adapter 16, which drives/supports a display 18, is also coupled to system bus 15. System bus 15 is coupled via a bus bridge 20 to an input/output (I/O) bus 22. An I/O interface 24 is coupled to (I/O) bus 22. I/O interface 24 affords communication with various I/O devices, including a keyboard 26, a mouse 28, a media tray 30 (which may include storage devices such as CD-ROM drives, multi-media interfaces, etc.), a printer 32, and external USB port(s) 34. While the format of the ports connected to I/O interface 24 may be any known to those skilled in the art of computer architecture, in a preferred embodiment some or all of these ports are universal serial bus (USB) ports.

As depicted, computer 12 is able to communicate with a software deploying server 36 and central service server 38 via network 40 using a network interface 42. Network 40 may be an external network such as the Internet, or an internal network such as an Ethernet or a virtual private network (VPN).

A storage media interface 44 is also coupled to system bus 15. The storage media interface 44 interfaces with a computer readable storage media 46, such as a hard drive. In a preferred embodiment, storage media 46 populates a computer readable memory 48, which is also coupled to system bus 15. Memory 48 is defined as a lowest level of volatile memory in computer 12. This volatile memory includes additional higher levels of volatile memory (not shown), including, but not limited to, cache memory, registers and buffers. Data that populates memory 48 includes computer 12's operating system (OS) 50 and application programs 52.

The operating system 50 includes a shell 54, for providing transparent user access to resources such as application programs 52. Generally, shell 54 is a program that provides an interpreter and an interface between the user and the operating system. More specifically, shell 54 executes commands that are entered into a command line user interface or from a file. Thus, shell 54, also called a command processor, is generally the highest level of the operating system software hierarchy and serves as a command interpreter. The shell 54 provides a system prompt, interprets commands entered by keyboard, mouse, or other user input media, and sends the interpreted command(s) to the appropriate lower levels of the operating system (e.g., a kernel 56) for processing. Note that while shell 54 is a text-based, line-oriented user interface, the present disclosure will equally well support other user interface modes, such as graphical, voice, gestural, etc.

As depicted, operating system (OS) 50 also includes kernel 56, which includes lower levels of functionality for OS 50, including providing essential services required by other parts of OS 50 and application programs 52, including memory management, process and task management, disk management, and mouse and keyboard management.

Application programs 52 include a renderer, shown in exemplary manner as a browser 58. Browser 58 includes program modules and instructions enabling a world wide web (WWW) client (i.e., computer 12) to send and receive network messages to the Internet using hypertext transfer protocol (HTTP) messaging, thus enabling communication with software deploying server 36 and other described computer systems.

The hardware elements depicted in computer 12 are not intended to be exhaustive, but rather are representative to highlight components useful by the present disclosure. For instance, computer 12 may include alternate memory storage devices such as magnetic cassettes (tape), magnetic disks (floppies), optical disks (CD-ROM and DVD-ROM), and the like. These and other variations are intended to be within the spirit and scope of the present disclosure.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In one embodiment of the invention, application programs 52 in computer 12's memory (as well as software deploying server 36's system memory) may include a graphics application program 60, such as a digital art program that simulates the appearance and behavior of traditional media associated with drawing, painting, and printmaking.

Turning now to FIG. 2, an application window 62 of a graphics application program 60 is depicted, according to one embodiment of the invention. The primary elements of the application window 62 include a menu bar 64 to access tools and features using a pull-down menu; a standard toolbar 66 containing shortcuts to basic menus and commands; a property bar 68 for displaying controls related to the active tool; a toolbox 70 to access tools for creating, filling, and modifying objects in a document; a document window 72 to provide a working space for a document; a rectangular drawing page 74 representing the printable section of the document in the document window 72; a document palette 76 to keep track of the colors used in the document; a RGB color palette 78 to select a color swatch; and one or more docker panels 80 to access commands and settings associated with a specific tool or task.

In the illustrated embodiment, the docker panel 80 is a color docker, although a large selection of docker panels may be available, such as panels for object properties and color styles, for example. In one example, the color docker provides several different methods to choose and edit colors. The setting currently in use displays a CMYK color palette 78, as opposed to the RGB palette shown on the right edge of the application window 62. Alternate graphical user interfaces for displaying colors may include a color view 82 or a color slider 84. All three convey the same information about the choice of color, but the particular user interface (UI) selected by a user will depend on the task.

The color docker panel 80 in FIG. 2 utilizes the CMYK color model to represent the color spectrum. A color model is a system that defines the number and kind of colors that make up an image. The CMYK color model is used in printing and includes the components cyan (C), magenta (M), yellow (Y), and black (K) to define color. Typically the values for each component are represented as percentages and vary from 0 to 100. If the value of each color component (e.g., C, M, and Y) is 0, the resulting color is white. Conversely, if the value of each color component is 100, the resulting color is black. That is, black is the result of combining the three CMY colors at their maximum intensities. Black (K) is included in the color model for printing purposes because black ink is more neutral and darker than blending equal amounts of C, M, and Y. Black ink produces sharper results, especially for printed text. In addition, black ink is usually less expensive than using colored ink.

The choice of color model is merely exemplary to further describe embodiments of the invention herein. Other color models contemplated within the scope of the invention may include, but are not limited to, Lab color space, HSB (Hue Saturation Brightness), RGB (Red Green Blue), YCbCr, grayscale, or any other color space.

Three color styles have been chosen from the CMYK color palette 78 and applied to the graphic on drawing page 74. A color style may be defined as a set of attributes, values, or color components 85 that control the appearance of the color. The first color style 86a (A) is yellow, having CMYK color component values 85 of (0, 0, 40, 0), as shown on the right edge of the color docker panel 80. The second color style 86b (B) is blue, having CMYK values of (60, 20, 0, 0), and the third color style 86c (C) is purple, having CMYK values of (60, 40, 0, 0). Color styles can be chosen from palettes or customized by the user.

FIG. 3 depicts a Color Styles docker panel 80 that may be used in the graphics application program 60. An upper region 88 of the panel provides a collection area for color styles, and a lower region 90 provides a collection area for color harmonies 92. A color harmony is a group of color styles that are linked together into hue-based relationships and modified together. Editing color styles in a harmony allows a user to quickly create a variety of alternate color schemes by shifting the colors together. When an edit is performed on a harmony, all color styles are changed simultaneously by preserving the relationship between them. The harmony 92 shown in FIG. 3 comprises the three color styles 86a, 86b, and 86c selected from the graphic illustration in FIG. 2.

The Color Styles docker panel 80 further includes a Harmony Editor 94 to assist the user in modifying the harmony 92. The Harmony Editor may be realized as graphical user interface (GUI) 96 with controls to carry out the modifications. In one embodiment, the GUI 96 represents a hue-saturation-value (HSV) cylindrical color model, wherein a color style can be created or defined by selecting values for the three components of the cylindrical color space: Hue (H), Saturation (S), and Value (V). The Hue component describes the pigment of the color, or the dominant wavelength in a color system. Hue is expressed in FIG. 3 by the angular position (e.g., degrees) on the color wheel 98. The Hue spans a ring of colors including the primary colors, their complements, and all of the colors in between: spanning in counter-clockwise circular motion from bottom dead center, the Hue varies from blue to magenta, to red, to yellow, to green, to cyan, and back to blue. Thus, in the illustrated embodiment, blue is located at 0°, magenta is at 300°, red at 270°, yellow at 160°, green at 100°, and cyan at 45°.

The component Saturation (S) can be described as the dominance of hue in the color, the ratio of the dominant wavelength to other wavelengths in the color, or simply the vividness or dullness of a color. In the illustrated HSV color model, the radial distance from the center point 100 of the cylinder to the edge of the cylinder can define the range of Saturation values. Values of Saturation vary from 0 to 100 and represent percentages of the radius of the color wheel. A point at the center point 100 can represent complete desaturation (e.g., 0% saturation level), and a point located on the outer circumference of the wheel can represent full saturation (e.g., 100% saturation level).

The component Value can be described as a brightness, an overall intensity or strength of the light. The values of Value (sometimes referred to as Brightness) vary from 0 to 100 and represent percentages of the slider control 102 beneath the color wheel.

In one example, a color style is converted to the HSV color model for display and modification on the color wheel 98, and the result is converted from HSV back to its original color model.

Each color style in the harmony (e.g., A, B, C) is depicted as a radial arm 104 extending from the center point 100 of the color model, the length of each arm corresponding to a saturation value (e.g., 0%-100% of the radius), and the angular location of each arm 104 corresponding to a hue value. Each arm 104 may further comprise a selector ring 106 to provide an easily identifiable feature to act upon with a mouse cursor, for example. In one embodiment, a reference or base color style having focus for editing may have a larger, white selector ring, and the remaining color styles may have a black selector ring. In FIG. 3, base color style A has focus for editing and the remaining color styles B and C are dormant. Thus, any editing action taken upon color style A, such as rotating it to change the hue value or modifying the radial length to change the saturation value, would be independent of color styles B and C.

In one implementation, each color style may be acted upon or selected for editing in two ways: by clicking on the selector ring 106 to edit the individual color style, or by clicking anywhere on the wheel which is not occupied by a selector ring to select all color styles in the harmony. In the latter example, all the selector rings may turn white, indicating they have focus for editing, but the controlling or base color style may have a larger sized ring to distinguish it from the remaining color styles.

FIG. 4 depicts such a scenario, wherein the color harmony comprising color styles A, B, and C are linked together into a hue-based relationship and modified together. All three color styles have white selector rings 106, indicating they have focus for editing. Color style A is the base color style (having the larger selector ring). The hue of color style B is separated from the hue of color style A by a degrees, and the hue of color style C is separated from the hue of color style A by β degrees. The dashed circle 108 in phantom denotes the saturation value of base color style A for any point on the circumference of the color wheel. Similarly, the difference in the saturation value between color styles A and B as well as the difference in the saturation value between color styles A and C can be seen graphically as the radial difference between circle 108 and the positions of color styles B and C respectively.

In operation, the base color style can be edited simply by moving the position of the selector ring with a mouse or other input device. As the base color style is rotated, for example, the remaining color styles rotate with it, keeping the same angular separation of a and β degrees. Similarly, as the saturation value of the base color style changes, the saturation value of the remaining color styles change proportionately.

In some circumstances, a user may desire to keep one of the color components of the graphical user interface constant while editing another. For example, the user may wish to fix or hold constant the value of the saturation component of the base color while modifying the hue value. To this end, in one embodiment of the invention, program instructions for the graphics application program 60 may create a rule to constrain at least one of the color components of the harmony while other components are being modified. In one example, the rule is to fix the value of saturation. The rule may be invoked by a keyboard command, for example, such as by pressing and holding the CTRL key. When the CTRL key is held down, the dashed circle 108 may appear in the GUI 96, and movement of color style A is constrained such that the selector ring 106 follows the circle. Likewise, the remaining color styles in the harmony will also follow a circular path while maintaining the angular separation from the base color style. In this manner, the saturation values for all the color styles in the harmony 92 remain constant.

In another example, the user may wish to fix or hold constant the value of the hue component of the base color while modifying the saturation value. To this end, in one embodiment of the invention, program instructions for the graphics application program 60 may create a rule to constrain the hue value while the saturation is being modified. The rule may be invoked by a keyboard command, for example, such as by pressing and holding the SHIFT key. When the SHIFT key is held down, movement of color style A is constrained such that the selector ring 106 only moves in a radial direction and does not rotate around the color wheel. Likewise, movement of the remaining color styles in the harmony will be constrained to radial movements only in proportion to the movement of the base color style. In this manner, the hue values for all the color styles in the harmony 92 remain constant.

In another example, the user may wish to ‘snap’ one color style onto another color style, in other words match the value of the hue. To this end, in one embodiment of the invention, program instructions for the graphics application program 60 may create a rule to constrain the hue value of the base color style to the hue value of a different color style in the color model graphical user interface. The rule may be invoked by a keyboard command, for example, such as by pressing and holding the ALT key. When the ALT key is held down, the base color style ‘snaps’ to one of the existing color styles. The particular color style to which it is snapped may be selected by the user, for example by hovering over it with the mouse. Alternately, program instructions may direct the base color style to snap to the closest color style. In other embodiments, it is also possible to snap to the pre-modification hue of the base color. Thus, it is possible to snap to hues of all colors rather than just the others.

In another example, the user may wish to simultaneously constrain the hue value of the base color style to the hue value of a different color style in the harmony and constrain a value of the saturation component of the base color.

The graphics application program 60 may include a set of harmony rules in the application software. When invoked, harmony rules position the color styles in a predetermined pattern. The harmony rules can apply a rule to shift all colors according to predetermined logic and create various color schemes. Referring now to FIG. 5, several examples of harmony rule GUIs 96a-96f are illustrated and explained briefly below.

Analogous Rule GUI 96a: includes colors that are next to each other on the color wheel, creating clear and smooth color schemes.

Analogous-Accented Rule GUI 96b: similar to the Analogous rule, but includes a complementary (contrasting) color in addition to the adjacent colors.

Complementary Rule GUI 96c: balances the base color style with the opposite color on the color wheel. Warm and cold colors are created for vibrant and energetic color schemes.

Monochromatic Rule GUI 96d: includes variations of a single color, creating soothing color schemes.

Tetrad Rule GUI 96e: based on a pair of colors and their complements on the color wheel. This rule usually creates bold color harmonies.

Triad Rule GUI 96f: balances the base color style with colors that are situated close to the opposite end of the color wheel, forming a triangle. This harmony rule usually creates color schemes of soft contrast.

FIG. 6 depicts a harmony rule GUI 96 according to another embodiment of the invention. Here, the user invoked the Tetrad Rule but only had three color styles. In other words, the harmony rule required at least a pre-defined number of color styles, in this case four, but the actual number of color styles in the harmony (in this case three) is less than the pre-defined number. In such a case, program instructions may direct the computer to draw a placeholder 110 on the color wheel. The placeholder 110 occupies a position on the color wheel where a color style would have been located to conform to the harmony rule. In one embodiment, the placeholder 110 comprises an empty arm depicted as dashed lines with no selector ring. In FIG. 6, two empty arms are shown since two of the three color styles have the same hue value. The empty arms can be particularly useful for other editing tasks. For example, the placeholder 110 could be used as a reference point or guide in relation to choosing another color style. Actual color styles could be aligned in complimentary fashion, offset by hue, etc. The harmony rule could be used to locate the placeholder 110, and the user could reference it without having to actually pick a color that would subsequently be deleted.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been described, it will be understood that features and aspects that have been described with reference to each particular embodiment can be used with each remaining particularly described embodiment.

What is claimed is:

1. A method for controlling color styles in a graphics application program executing on a computer, comprising the steps of:
selecting a plurality of color styles;
grouping the color styles into a harmony;
displaying a color model graphical user interface representative of each color style in the harmony;
creating a rule in program instructions for the graphics application program to constrain at least one color component of the color model graphical user interface;
selecting a base color style within the color model graphical user interface for editing;
invoking the rule so the computer executes instructions to constrain the color component of the color model graphical user interface;
while in the constrained state, modifying a color component of the base color style with the graphical user interface; and
proportionately modifying, by the computer, the corresponding color component of the remaining color styles in the color model graphical user interface.

2. The method according to claim 1, wherein the color model graphical user interface is selected from the group consisting of CMYK, RGB, HSV, Lab model, and YCbCr.

3. The method according to claim 1, wherein the rule is to constrain a value of the hue component of the base color.

4. The method according to claim 1, wherein the rule is to constrain a value of the saturation component of the base color.

5. The method according to claim 1, wherein the rule is to constrain the hue value of the base color style to the hue value of a different color style in the color model graphical user interface.

6. The method according to claim 1, wherein the rule is to simultaneously constrain the hue value of the base color style to the hue value of a different color style in the color model graphical user interface and constrain a value of the saturation component of the base color.

7. The method according to claim 1, wherein the step of applying a rule comprises entering a keyboard short cut.

8. The method according to claim 1, wherein the step of applying a rule comprises invoking a harmony rule.

9. The method according to claim 8, wherein the harmony rule is selected from the group consisting of Analogous, Analogous-Accented, Complementary, Monochromatic, Tetrad, and Triad.

10. The method according to claim 8, wherein the harmony rule requires at least a pre-defined number of color styles, and the actual number of color styles in the harmony is less than the pre-defined number.

11. The method according to claim 10, wherein the harmony rule is Tetrad, and the harmony comprises less than four color styles.

12. The method according to claim 10, wherein the harmony rule is Triad, and the harmony comprises less than three color styles.

13. The method according to claim 10, wherein the graphical user interface depicts the missing color styles as a placeholder.

14. The method according to claim 13, wherein the color model graphical user interface comprises a hue-saturation-value cylindrical color model, each color style in the harmony being depicted as an arm extending radially from a center point of the color model, each arm having a radial component corresponding to a saturation value and an angular component corresponding to a hue value, and the placeholder comprises an empty arm.

15. A digital graphics computer system, comprising:
a computer, comprising:
one or more processors;
one or more computer-readable memories;
one or more computer-readable tangible storage devices; and
program instructions stored on at least one of the one or more storage devices for execution by at least one of the one or more processors via at least one of the one or more memories;
a display connected to the computer;
the computer program instructions comprising:
program instructions for executing a graphics application program and outputting to the display;
program instructions for selecting a plurality of color styles;
program instructions for grouping the color styles into a harmony;
program instructions for displaying a color model graphical user interface representative of each color style in the harmony;
program instructions for creating a rule to constrain at least one color component of the color model graphical user interface;
program instructions for selecting a base color style within the color model graphical user interface for editing;
program instructions for invoking the rule so the computer executes instructions to constrain the color component of the color model graphical user interface;
program instructions for modifying a color component of the base color style with the graphical user interface while in the constrained state; and
program instructions for proportionately modifying the corresponding color component of the remaining color styles in the color model graphical user interface.

16. The digital graphics computer system according to claim 15, wherein the program instructions constrain a value of the hue component of the base color.

17. The digital graphics computer system according to claim 15, wherein the program instructions constrain a value of the saturation component of the base color.

18. The digital graphics computer system according to claim 15, wherein the program instructions constrain the hue value of the base color style to the hue value of a color style in the color model graphical user interface.

19. The digital graphics computer system according to claim 15, wherein the program instructions apply the rule in response to entering a keyboard short cut.

20. The digital graphics computer system according to claim 15, wherein the program instructions invoke a harmony rule.

21. The digital graphics computer system according to claim 20, wherein the harmony rule requires at least a pre-defined number of color styles, and the actual number of color styles in the harmony is less than the pre-defined number.

22. The digital graphics computer system according to claim 20, wherein the graphical user interface depicts the missing color styles as a placeholder.

23. The digital graphics computer system according to claim 22, wherein the color model graphical user interface comprises a hue-saturation-value cylindrical color model, each color style in the harmony being depicted as an arm extending radially from a center point of the color model, each arm having a radial component corresponding to a saturation value and an angular component corresponding to a hue value, and the placeholder comprises an empty arm.
